(19) United States
(12) Patent Application Publication
(10) Pub. No.: US 2021/0359641 A1
(43) Pub. Date: Nov. 18, 2021

(54) SOLAR CELL MODULE FOR MOTOR VEHICLE

(71) Applicant: Ford Global Technologies, LLC, Dearborn, MI (US)

(72) Inventors: Heike Alberg, Roesrath (DE); Oliver Henn, Euskirchen (DE)

(21) Appl. No.: 17/320,365

(22) Filed: May 14, 2021

(30) Foreign Application Priority Data
May 14, 2020 (DE) 102020206104.1

(51) Int. Cl. H02S 30/20; H02S 10/40; H02S 20/32; B60L 8/00

(52) U.S. Cl. CPC H02S 30/20; B60L 8/003; H02S 20/32; H02S 10/40

(57) ABSTRACT

A motor vehicle has an electric drive and a primary energy source for the electric drive. The vehicle also has a solar cell module for supplying the primary energy source. The solar cell module can be designed in such a manner that it can be moved to an expanded position while in use in order to increase its surface area, and then moved to a constricted position to reduce its size when not in use. The solar cell module is designed so that it can be rolled out, fanned out or erected in order to increase its surface area.

### CROSS-REFERENCE TO RELATED APPLICATIONS

This application claims priority to GB Patent Application No. 102020206104.1, which was filed on 14 May 2020 and is incorporated herein by reference in its entirety.

### TECHNICAL FIELD

The present disclosure relates to a motor vehicle having a solar cell module for supplying an electric drive.

### BACKGROUND

It is known to equip motor vehicles with so-called hybrid drives, in which case the drive of the vehicle is optionally effected electrically or, when the electrical power is used up or is insufficient, via internal combustion engines. In addition, it is also known to equip motor vehicles, as purely electric vehicles, with an electric drive.

In both cases, the motor vehicles require a primary energy source for the electric drive, which must be charged accordingly. This can be charged at fixedly installed charging stations or, during combustion-assisted driving, by the electric generator.

However, if the charging stations are occupied (or not available), solar cells could serve as an alternative.

So far, due to the power of solar cell modules, it is necessary to make them large in area and to track the position of the sun in order to obtain sufficient power.

DE 40 03 513 A1 discloses an energy package for a solar mobile that consists of foldable solar cell modules that can be aligned with the sun. When the vehicle is stationary, the energy package is unfolded to the largest possible surface area by means of fold-out hinge-connected modules and aligned with the sun, such that a maximum amount of electricity can be stored in the vehicle's batteries. For driving, the energy package is folded up to reduce drag and protect it from damage. The folding-up is effected in such a manner that a residual module surface remains facing the sun. In order to enable the batteries to be charged even in the case of voltage drop due to partial shading or a reduction in surface area, a circuit is provided that charges just as many of the series-connected batteries as corresponds to the voltage available.

A similar concept of improving performance by tracking is disclosed in DE 10 2008 046 798 A1.

### SUMMARY

Exemplary embodiments of the present disclosure provide a simplified alternative for increasing the surface area of a solar cell module while in use, which is nevertheless easily stowable.

It has been recognized that, if the solar cell module is designed so that it can be rolled out, fanned out or erected in order to increase the surface area while in use, handling of the solar cell module during increasing of the surface area becomes more flexible and simpler, and it can be stowed inside the vehicle when not in use.

In addition, it is possible for the solar cell module to be tracked to the position of the sun via a tracking assembly that includes sun sensors, in order, in a known manner, to optimize the angle of solar radiation and thus the output.

Expediently, when not in use the solar cell module is stowed inside the vehicle body. In other words, it is not only recessed in the roof of the vehicle body (as in the prior art in the manner of a roof tent or sunroof), but is accommodated completely inside, for example inside the boot or other cavities. This may be effected in an automated, manual or fully automatic manner.

This disclosure described exemplary embodiments that achieve an increase in surface area, namely fanning out, erecting and rolling out. The solar cell module of these embodiments can have sub-modules that are movable about a central fastening axis.

The solar cell module can have solar lamellae that can be fanned out about a central fastening axis, or have a solar textile that can be erected about a central fastening axis in the manner of an umbrella, or have a solar textile that can be rolled out about a central fastening axis, or have flexible solar modules that can be rolled out and are connected to one another transversely.

### BRIEF DESCRIPTION OF THE FIGURES

The various features and advantages of the disclosed examples will become apparent to those skilled in the art from the detailed description. The figures that accompany the detailed description can be briefly described as follows.

FIG. 1 shows a schematic view of a motor vehicle having a solar cell module according to an exemplary embodiment of the present disclosure.

FIG. 2 shows a schematic view of a motor vehicle having a solar cell module according to another exemplary embodiment of the present disclosure.

FIG. 3 shows a schematic view of a motor vehicle having a solar cell module according to yet another exemplary embodiment of the present disclosure.

### DETAILED DESCRIPTION

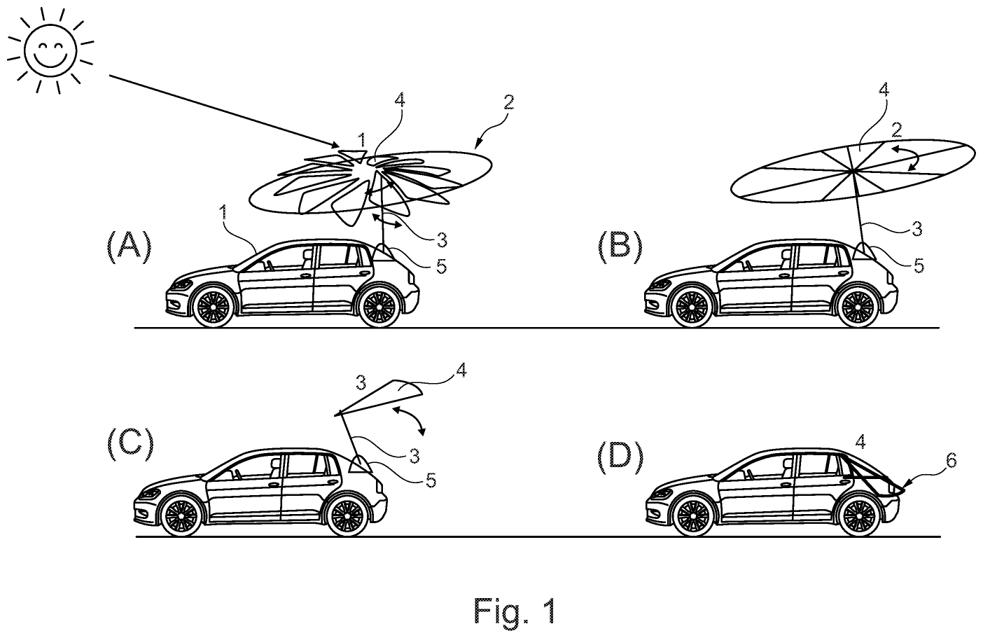

FIGS. 1 to 3 show different examples of a motor vehicle 1 having an electric drive and a primary energy source for the electric drive. The vehicles 1 have a solar cell module 2 for supplying the primary energy source. The solar cell module 2 can be designed in such a manner that it can be expanded while in use in order to increase its surface area, and constricted to reduce its size when not in use.

FIGS. 1A, 2A, and 3A show the example vehicles 1 when embodiments of the solar cell module 2 are in an expanded position (e.g., unfolded) and in use. FIGS. 1D, 2D, and 3D show the example vehicles when embodiments of the solar cell module 2 are in a constricted position (e.g., folded up) and not in use.

For this purpose, the respective solar cell module 2 is designed so that it can either be fanned out or erected or rolled out to increase the surface area.

For this purpose, each solar cell module 2 has sub-modules 4 that can be moved about a central fastening axis 3.

The respective solar cell module 2 can be tracked to the position of the sun via a tracking means comprising sun sensors 5.

When not in use, the respective solar cell module 2, after being reduced in size as shown in FIGS. 1B to 1C, 2B to 2C, and 3B to 3C can be stowed in the boot 6 inside the vehicle body.

In the first exemplary embodiment of FIG. 1A to 1D, the solar cell module 2 is designed with sub-modules 4 as solar lamellae that can be fanned out about the central fastening axis 3. The lamellae can be rotated relative to each other about the central axis 3 to increase the active surface area of the solar module 2, and are thus brought to a non-overlapping position in order to assume the state of use.

Conversely, in order to assume the non-use state of FIG. 1C, the lamellae are rotated relative to each other about the central axis 3 and thus brought to a constricted and overlapping position to reduce their size. They can then be stowed as a package in the boot 6.

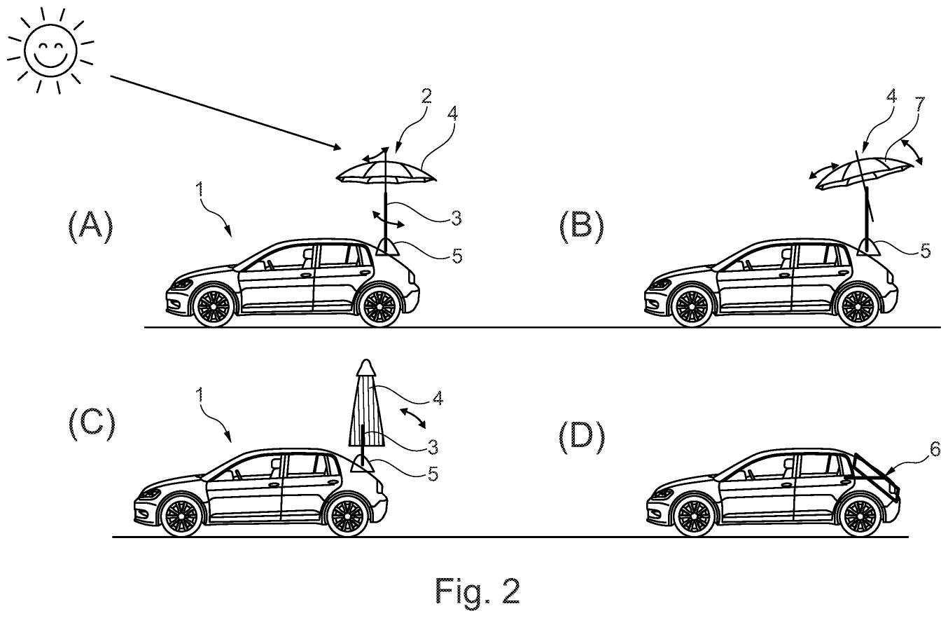

With reference to FIG. 2, the solar module is used in a similar manner if the solar cell module 2 has a solar sub-module 4 that is a solar textile. The solar textile can be erected about a central fastening axis 3 in the manner of an umbrella. The solar textile in this case may be composed of individual circle-segment pieces 7.

The solar cell module 2 may be erected or folded up like a parasol, via the corresponding linkages on the central axis 3. FIG. 2 shows a parasol style embodiment.

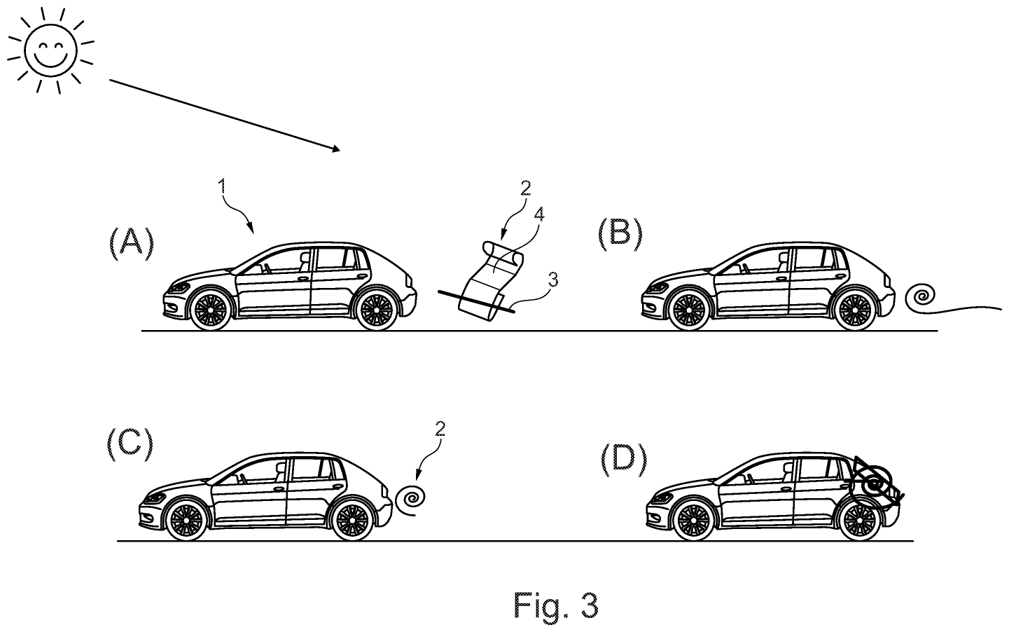

In contrast to the embodiments of FIGS. 1 and 2, the embodiment according to FIG. 3 is realized as a solar sub-module 4 having a solar textile that can be rolled out about a central fastening axis 3 and is aligned manually. The solar textile in the embodiment of FIG. 3 can include solar modules that are rolled out and connected to one another transversely.

In other examples, the unrolling and rolling-up may be automated.

In the embodiment of FIG. 3, the solar cell module can be simply unrolled on the ground at a free location and aligned as optimally as possible to the sun without shading. After use, it is rolled back up and stowed in the boot 6.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. A motor vehicle assembly, comprising:
a solar cell module for supplying a primary energy source of a motor vehicle, the solar cell module configured to be transitioned to an expanded position while in use such that a surface area is increased, the solar cell module configured to be transitioned to a constricted position when not in use such that a size of the of the solar cell module is reduced, the solar cell module configured to be stowed inside the vehicle body when in the constricted position.

2. The motor vehicle assembly of claim 1, wherein the solar cell module is configured to be rolled out from the constricted position to the expanded position.

3. The motor vehicle assembly of claim 2, further comprising a solar textile of the solar cell module, the solar textile configured to be rolled out about a central fastening axis.

4. The motor vehicle assembly of claim 2, wherein the solar cell module includes a plurality of solar modules that are individually rolled out and connected to each other transversely.

5. The motor vehicle assembly of claim 1, wherein the solar cell module is configured to be fanned out from the constricted position to the expanded position.

6. The motor vehicle assembly of claim 5, further comprising a plurality of solar lamellae of the solar cell module, the solar lamellae configured to be fanned out about a central fastening axis when the solar cell module is transitioned from the constricted position to the expanded position.

7. The motor vehicle assembly of claim 1, wherein the solar cell module is configured to be erected from the constricted position to the expanded position.

8. The motor vehicle assembly of claim 7, further comprising a solar textile of the solar cell module, the solar textile configured to be erected about a central fastening axis in the manner of an umbrella when the solar cell module is transitioned from the constricted position to the expanded position.

9. The motor vehicle assembly of claim 1, further comprising an electric drive and the primary energy source for the electric drive.

10. The motor vehicle assembly of claim 1, wherein the solar cell module is configured to be tracked to a position of the sun via a tracking assembly that includes sun sensors.
